(19) United States
(12) Patent Application Publication
(10) Pub. No.: US 2009/0090164 A1
(43) Pub. Date: Apr. 9, 2009

(54) METHOD FOR VOLUMETRICALLY CALIBRATING A LIQUID FLOW CONTROLLER WHILE MAINTAINING THE LIQUID IN A CLOSED SYSTEM

(75) Inventor: Ronald S. INMAN, Brookfield, IL (US)

Correspondence Address: AIR LIQUIDE;Intellectual Property, 2700 POST OAK BOULEVARD, SUITE 1800, HOUSTON, TX, 77056, US

(73) Assignee: Air Liquide Electronics U.S. LP, Houston, TX (US)

(21) Appl. No.: 11/932,635

(22) Filed: Oct. 31, 2007

Related U.S. Application Data
(60) Provisional application No. 60/978,334, filed on Oct. 8, 2007.

(51) Int. Cl. G01F 25/00

(52) U.S. Cl. 73/1.25

(57) ABSTRACT

Methods and apparatus for determining if it is necessary to calibrate a liquid flow controller which is contained in a liquid distribution system, where the liquid distribution system supplies a fluid to a semiconductor processing tool. The determination is made while maintaining system as closed, such that fluid does not need to be removed from the liquid distribution system.

### CROSS REFERENCE TO RELATED APPLICATIONS

The present application claims the benefit of U.S. Provisional Application Ser. No. 60/978,334, filed Oct. 8, 2007, herein incorporated by reference in its entirety for all purposes.

### BACKGROUND

1. Field of the Invention

This invention relates generally to the field of semiconductor fabrication. More specifically, the invention relates to a method of determining if calibration is necessary for a liquid flow controller contained in a liquid distribution system and used for semiconductor fabrication.

2. Background of the Invention

As electronic devices and the integrated circuits they contain evolve and become more complex, the manufacturing processes which produce these semiconductor devices must also evolve. Numerous chemical components are utilized in the production of a single integrated circuit, all of which need to be provided and distributed within the semiconductor manufacturing facility. Liquid distribution systems take the required liquid chemicals from their storage point, and provide them to the end point of use, which is often the semiconductor processing tool. As the purity requirements for these chemicals are often very strict, it is advantageous to deliver these chemicals in a manner which eliminates or minimizes the possibility of chemical contamination within the distribution system. Flow conditions, particularly flow rate, of the liquid chemical through the distribution system must also be controlled. One method to accomplish this is through the use of liquid flow controllers (LFCs), which monitor and control the flow rate of the liquid chemical. As with most devices, these LFCs must be periodically calibrated to ensure that they function properly. To calibrate the LFC, it is necessary to compare flow rate reported by the LFC with a second flow rate determined through another means. If the first and second flow rates are not the same (or statistically similar), then the LFC may need to be adjusted so that the first flow rate reported corresponds to the second flow rate observed. Typically, this second flow rate is determined by flowing fluid through the LFC and then into a container for a fixed period of time. The amount of fluid contained in the container is then measured to determine the second flow rate.

One conventional way of measuring the volume in the container is the volumetric approach where the container is removed from the system and the fluid within is transferred into a measuring device such as a graduated cylinder. Another volumetric approach is to have measuring graduations placed on the container, which allow a user to determine the liquid level in the container, after the container has been removed from system. Both of these volumetric approaches cause some safety concerns as they allow for exposure of the user to the chemical. Also, opening the system to remove the container increases the potential for impurity introduction into the liquid distribution system. Gravimetric methods to determine the amount of fluid in the container, such as weighing the container with the fluid, are also very common. These gravimetric methods also usually require the opening of the system, or providing additional equipment with the associated capital costs.

Consequently, there exists a need for a method to determine if it is necessary to calibrate a liquid flow controller while maintaining a liquid in a closed system.

### BRIEF SUMMARY

Novel methods for determining if it is necessary to calibrate a liquid flow controller while maintaining a liquid in a closed fluid distribution system are described herein. The disclosed methods allow the calibration of the liquid flow controller without removing the fluid from the closed system, or requiring a user to be exposed to contact with the fluid.

In one embodiment, a method for calibrating a liquid flow controller in a closed system comprises providing a liquid distribution system, which comprises a liquid flow controller, a pressure sensor, a calibration vessel, and an orifice. A fluid flows through the liquid distribution system, and the flow of the fluid is measured with the liquid flow controller to determine a first flow rate. The fluid flow is then diverted into the calibration vessel, which is of a known volume and substantially empty. An indication is received when the calibration vessel is full. This indication comprises registering a change in pressure of the fluid in the liquid distribution system, as measured by the pressure sensor. The change in pressure is caused by the fluid flowing out of the calibration vessel and through the orifice. The time to fill the calibration vessel is measured, and a second flow rate is determined based upon the time required to fill the known volume of the calibration vessel.

Other embodiments of the invention may include, without limitation, one or more of the following features:
the calibration vessel is drained, and dried with an inert gas after the second flow rate is determined;
the pressure sensor is provided at a point which is upstream of the calibration vessel and downstream of the liquid flow controller;
the orifice is an adjustable type orifice;
the orifice is a fixed size orifice;
the orifice is adjusted based upon the flow rate of the fluid, such that the orifice is made smaller for lower flow rates and the orifice is made larger for higher flow rates;
the first and the second flow rates are compared to determine if the liquid flow controller needs to be recalibrated;
a programmable logic controller is provided;
a signal is sent from the logic controller to a valve located upstream of the calibration vessel, the valve is actuated, and diverts the flow into the vessel;
a signal is sent from the pressure sensor to the logic controller when the pressure sensor registers the change in pressure which indicates that the calibration vessel is full;
the logic controller determines the time to fill the calibration vessel by calculating the time between when the signal is sent to the valve, and when the signal is received from the pressure sensor;
a signal indicative of the first flow rate is sent from the flow controller to the logic controller;
the second flow rate is determined by the logic controller by dividing the known volume of the calibration vessel by the time needed to fill the vessel;
the difference between the first and second flow rates is determined by the logic controller;
a signal indicative of the difference between the first and second flow rates is sent from the logic controller to a user interface;
a signal is sent from the logic controller to the adjustable orifice;
the adjustable orifice size is changed based upon the signal indicative of the first flow rate, and the signal from the logic controller to the orifice;
the fluid distribution system provides a fluid to a semiconductor processing tool;
the fluid flowing through the distribution system may be hydrofluoric acid; sulfuric acid; hydrogen peroxide; hydrochloric acid; nitric acid; ammonium hydroxide; tetramethyl ammonium hydroxide (TEMAH); water; and mixtures thereof;
the second flow rate is between about 10 ml/min and about 10 lpm; and
the second flow rate is determined without removing any fluid from the fluid distribution system.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic representation of one embodiment of a method for calibrating a liquid flow controller in a closed environment; and

FIG. 2 illustrates a schematic representation of a second embodiment of a method for calibrating a liquid flow controller in a closed environment.

### DESCRIPTION OF PREFERRED EMBODIMENTS

Generally, the current invention relates to a method for determining if it is necessary to calibrate a liquid flow controller in a closed system which comprises providing a liquid distribution system, the system comprising a liquid flow controller, a pressure sensor, a calibration vessel, and an orifice. A fluid flows through the liquid distribution system, and the flow of the fluid is measured with the liquid flow controller to determine a first flow rate. The fluid flow is then diverted into the calibration vessel, which is of a known volume and substantially empty. An indication is received when the calibration vessel is full. This indication comprises registering a change in pressure of the fluid in the liquid distribution system, as measured by the pressure sensor. The change in pressure is caused by the fluid flowing out of the calibration vessel and through the orifice. The time to fill the calibration vessel is measured, and a second flow rate is determined based upon the time required to fill the known volume of the calibration vessel. This second flow rate is determined without directly exposing a user to any of the chemicals contained within the system, and without opening the closed liquid distribution system to remove any of the liquid products which could possibly introduce contaminants to the supply system.

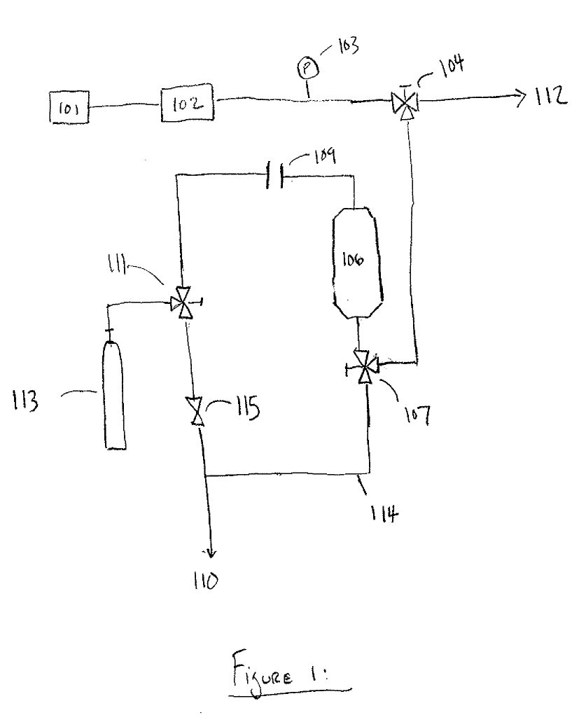

Referring now to FIG. 1, embodiments of the method according to the current invention are described hereafter. A liquid distribution system 100 is provided which may be used to supply various liquid chemicals in semiconductor manufacturing applications. Some examples of typical liquid chemical fluids distributed include, but are not limited to hydrofluoric acid; sulfuric acid; hydrogen peroxide; hydrochloric acid; nitric acid; ammonium hydroxide; tetramethyl ammonium hydroxide (TEMAH); water; and mixtures thereof;

Liquid chemical flows from its supply source 101 throughout the supply system 100. Flow rates of the liquid in supply system 100 may vary, but generally they may be between about 10 milliliters/minute to 10 liters/minute. In some embodiments the supply source 101 may be a large is volume or bulk supply source located some distance away from the ultimate point of use for the fluid. In other embodiments, the supply source 101 may be of a smaller total volume and located closer to the point of use, for instance, the supply source may be in the same room as the point of use. The flow of the liquid through the distribution system 100 is measured and controlled by a liquid flow controller (“LFC”) 102. LFC 102 may be a conventional type controller, such as an Entegris NT 6500 type LFC, which is commercially available from Entegris. As the fluid flows through the distribution system, LFC 102 monitors and, if necessary, controls the fluid flow rate.

Downstream of LFC 102 is a pressure sensor 103 which measures the pressure of the fluid in the distribution system. Pressure sensor 103 may be a conventional type pressure sensor, such as a CS-V010-15U-P300P pressure sensor, which is commercially available from Surpass Industries. In some embodiments pressure sensor 103 may be a mechanical gauge type sensor, while in other embodiments pressure sensor 103 may be an electro mechanical type sensor which is capable of sending an output signal indicative of the pressure.

Downstream of the pressure sensor 103 is a three-way valve 104 which may be used to divert the fluid flow into a calibration line 105 which leads to a calibration vessel 106. Calibration vessel 106 is of a known volume, has an inlet and an outlet, and is made of a material suitable for use in liquid distribution systems (for example, stainless steel or a polymer such as PFTE). Three-way valve 107 may be located upstream of the vessel's inlet. In some embodiments, the volume of the vessel 106 may be between about 200 ml and about 5 liters.

A restrictive flow orifice 109 is located downstream of the vessel's outlet. Orifice 109 may be a conventional type orifice such a fixed size restrictive flow orifice. In some embodiments, the orifice 109 may be an adjustable type orifice (either manually adjustable, or electrically adjustable), such as a conventional adjustable type orifice like a multi-turn valve, or an electrically adjustable orifice like the Futurestar 6AB-2S-3BR, available commercially from Futurestar and controllable by a PLC.

To determine if LFC 102 needs to be calibrated, a measurement of the flow rate of the system is initially taken from LFC 102 to serve as a base line, or first flow rate, measurement. The effluent from LFC 102 is then diverted is then diverted into the calibration vessel 106, for instance, by adjusting three-way valve 104 to allow the flow to enter calibration line 105, pass through three-way valve 107 and enter the calibration vessel 106. In some embodiments, calibration vessel 106 is situated such that the flow enters through the bottom of the vessel. Initially calibration vessel 106 is substantially empty of fluid, but may contain some atmosphere, such as an inert gas atmosphere (for instance, nitrogen, argon, or helium).

As the fluid fills the calibration vessel 106, any atmosphere in the calibration vessel 106 is forced out and leaves by passing through the vessel outlet and orifice 109. Once the calibration vessel 106 is full of fluid, the fluid will leave the vessel 106 and pass through the orifice 109. The dramatically higher viscosity of the fluid, as compared to that of the atmosphere, passing through the orifice 109 results in a pressure increase in the fluid line upstream of the calibration vessel 106. This pressure increase is registered by pressure sensor 103.

A second flow rate is calculated by dividing the known volume of the calibration vessel 106 (including in some embodiments any volume between the vessel outlet and the orifice 109, or between the vessel inlet and the three-way valve 107), by the elapsed time between when the flow was diverted and when the pressure increase was measured by the pressure sensor 103. This second flow rate is compared to the first flow rate, and can be used to determine if the LFC 102 needs to be calibrated, for instance, if the two flow rates are not approximately equal.

In some embodiments, the calibration vessel 106 and the calibration line 105 may be drained after the second flow rate is determined. For instance, three-way valve 104 may be closed such that the flow is diverted from calibration line 105 back towards the point of use 112. Three-way valve 107 may then be closed so as to allow calibration line 105 to empty through line 114 to drain 110. Turning three-way valve 107 to its other configuration then allows calibration tank 106 to drain any fluid contained therein, through line 114 to drain 110. In some embodiments calibration tank 106 is orientated in such a way that gravitational forces aid in this draining. In these embodiments, the drains from calibration tank 106 in the opposite direction from which it was filled to avoid fighting gravity while trying to empty the tank. Also, calibration tank 106 may have a physical configuration which aids in this draining, for instance, the bottom of calibration tank 106 may have a non-flat or dished shape.

In some embodiments, calibration tank 106 may be dried after it is drained. The drying may be accomplished by attaching an inert gas source 113 to liquid distribution system 100, via a three-way valve 111. Drain valve 115 may also be located between three-way valve 111 and drain 110. Drain valve 115 may be closed when calibration tank 106 is dried with inert gas source 113. Inert gas source 113 may be conventional source such as a compressed gas cylinder, or may be provided by a connection to another existing inert gas application or supply line. An inert gas (such as nitrogen, helium, or argon) may then be sent from inert gas source 113, through three-way valve 111, orifice 109, and into tank 106. The inert gas may then exit tank 106 through three-way valve 107, and exit the system via line 114 to drain 110. As the inert gas flows in this manner, it may help to remove any remaining liquid present in these components. In some embodiments, the calibration tank 106 may be dried concurrently with its draining, so that the inert gas may encourage the draining of the fluid from tank 106.

In some embodiments the orifice 109 is an adjustable type orifice. In these embodiments, the orifice size is adjusted based upon the general flow rate of the fluid in the system. For instance, for high fluid flow rates the orifice size is adjusted to be larger, and for lower flow rates the orifice size is adjusted to be smaller. Adjusting the orifice size allows for the pressure increase to be more easily observed by pressure sensor 103.

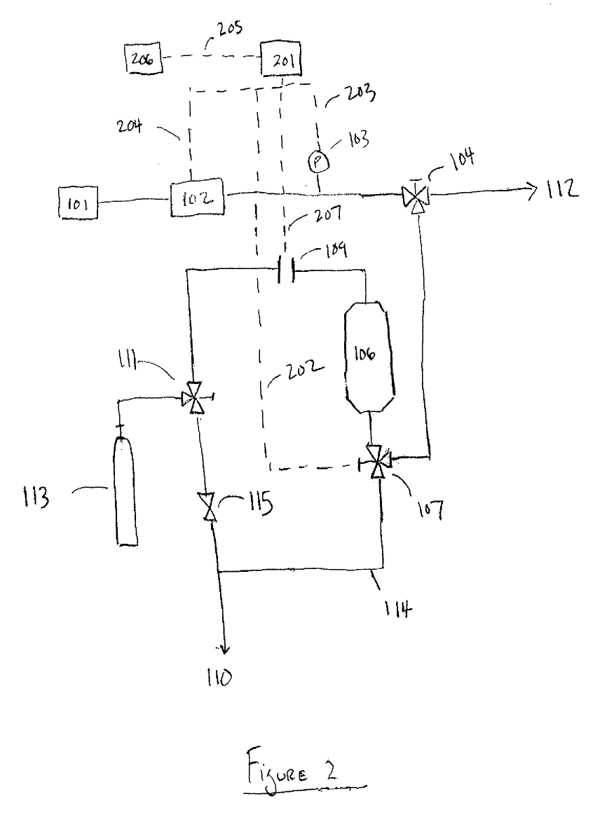

Referring now to FIG. 2, another exemplary embodiment in accordance with the invention is shown. In some embodiments, automation of the calibration method is possible and to this end a controller 201 is provided. Controller 201 may be a conventional type controller, such as a programmable logic controller, Such as a CPU315-2DP type controller, manufactured by Siemens. Generally, controller 201 is capable of both sending and receiving signals, such as 4-20 mA, or 0-10 volt type signals.

In some embodiments, three-way valve 104 diverts the flow into line 105, while three-way valve 107 is closed such that the flow does not enter calibration tank 106. A signal 202 is sent from controller 201 to three-way valve 107, and three-way valve 107 then allows the flow of the fluid into calibration tank 106.

When pressure sensor 103 registers an increase in pressure indicative of the fluid flowing out of calibration tank 106 and through the orifice 109, pressure sensor 103 sends a signal 203 to controller 201. Controller 201 then calculates the time between the signal 202 to three-way valve 107 and the signal 203 from pressure sensor 103, this time being indicative of the time to fill the known volume of the vessel. LFC 102 may also send a signal 204, which is indicative of the first flow rate, to controller 201. Controller 201 may then calculate the second flow rate by dividing the known volume of the calibration tank 106 (including in some embodiments any volume between the vessel outlet and the orifice 109, or between the vessel inlet and the three-way valve 107) by the time between signal 202 and signal 203. A comparison between the first and second flow rates can then be made my controller 201. A user interface 206, such as a conventional graphical user interface (e.g. a computer monitor) is provided, and a signal 205 indicative of the difference between the first and second flow rates may be sent to user interface 206 by controller 201.

In other embodiments, controller 201 may send a signal 207 to orifice 109, where this signal is indicative of the first flow rate as measured by LFC 102 and sent to controller 201 as signal 204. The orifice 109 may then be adjusted in size based upon the signal 204 indicative of the first flow rate and the signal 207 from the controller 201.

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. A method for determining if it is necessary to calibrate a liquid flow controller while maintaining liquid in a closed system, comprising:
a) providing a liquid distribution system which comprises a liquid flow controller, a pressure sensor, a calibration vessel, and an orifice;
b) flowing a fluid through the liquid distribution system;
c) measuring the flow of the fluid through the distribution system with the liquid flow controller to determine a first flow rate;
d) diverting the fluid flow into the calibration vessel, wherein the calibration vessel is of a known volume and initially substantially empty;
e) receiving an indication when the calibration vessel is full, wherein receiving the indication comprises registering, with the pressure sensor, a change of pressure in the liquid distribution system, the pressure change caused by the fluid flowing out of the vessel and through the orifice;
f) measuring the time between diverting the fluid flow and receiving the indication; and
g) determining a second flow rate by based upon the known volume of the calibration vessel and the determined time.

2. The method of claim 1, further comprising:
a) draining the vessel after the second flow rate is determined; and
b) drying the vessel by flowing an inert gas through the vessel.

3. The method of claim 1, further comprising:
a) providing the pressure sensor at a point upstream of the of the calibration vessel, and downstream of the liquid flow controller.
b) providing the calibration vessel at a point downstream of the liquid flow controller.

4. The method of claim 1, wherein the orifice is an adjustable type orifice.

5. The method of claim 5, further comprising adjusting the orifice based upon the flow rate of the fluid, such that the orifice is made smaller for lower flow rates, and the orifice is made larger for larger flow rates.

6. The method of claim 1, further comprising comparing the first and second flow rates to determine if the liquid flow controller needs to be recalibrated.

7. The method of claim 1, further comprising:
a) providing a programmable logic controller;
b) sending a signal from the logic controller to a valve located upstream of the calibration vessel, wherein the valve then allows the flow into the vessel;
c) sending a signal from the pressure sensor to the logic controller when the pressure sensor registers the change in pressure which indicates that the vessel is full; and
d) calculating with the logic controller, the time between the signal to the valve and the signal from the pressure sensor to determine the time to fill the vessel.

8. The method of claim 7, further comprising:
a) sending a signal from the flow controller to the logic controller, wherein the signal is indicative of the first flow rate;
b) calculating with the logic controller, the second flow rate; and
c) calculating with the logic controller the difference between the first and second flow rates; and
d) sending a signal, indicative of the difference between the first and second flow rates, from the logic controller to a user interface.

9. The method of claim 7, further comprising:
a) sending a signal from the flow controller to the logic controller, wherein the signal is indicative of the first flow rate;
b) sending a signal form the logic controller to the orifice, wherein the orifice is an adjustable type orifice; and
c) adjusting the orifice size based upon the signal indicative of the first flow rate and the signal from the logic controller to the orifice.

10. The method of claim 1, wherein:
a) the fluid distribution system provides a fluid to a semiconductor processing tool; and
b) the fluid flowing through the distribution system comprises at least one member selected from the group consisting of: hydrofluoric acid, sulfuric acid, hydrogen peroxide, hydrochloric acid, nitric acid, ammonium hydroxide, tetramethyl ammonium hydroxide (TEMAH), water; and mixtures thereof.

11. The method of claim 11, wherein second flow rate is between about 10 ml/min and about 10 liters/min.

12. The method of claim 1, wherein the second flow rate is determined without removing any of the fluid from the fluid distribution system.
